(19) United States
(12) Patent Application Publication
(10) Pub. No.: US 2020/0005243 A1
(43) Pub. Date: Jan. 2, 2020

(54) AUTOMATING CANDIDATE WORKFLOWS USING CONFIGURABLE RULES AND NETWORK SIGNALS

(71) Applicant: Microsoft Technology Licensing, LLC, Redmond, WA (US)

(72) Inventors: Wai Lim W. Pong, San Jose, CA (US); Viman Deb, San Jose, CA (US); Manish Baldua, San Jose, CA (US); Shidong Yan, Newark, CA (US); Li Zhou, Sunnyvale, CA (US); Tao Zheng, Redwood City, CA (US)

(73) Assignee: Microsoft Technology Licensing, LLC, Redmond, WA (US)

(21) Appl. No.: 16/020,640

(22) Filed: Jun. 27, 2018

(51) Int. Cl. G06Q 10/10; G06Q 10/06

(52) U.S. Cl. CPC G06Q 10/1053; G06Q 50/01; G06Q 10/063112; G06Q 10/0633

(57) ABSTRACT

The disclosed embodiments provide a system for processing data. During operation, the system stores, in a repository, a set of configurable rules for managing hiring workflows in an applicant tracking system, wherein each configurable rule in the set of configurable rules includes a trigger representing activity associated with an online network, a condition to be evaluated in response to the trigger, and an action to be performed when the condition is met. Next, the system matches recent activity associated with a candidate in an applicant tracking system to the trigger in a configurable rule from the repository. Next, the system evaluates the condition from the configurable rule using attributes associated with the candidate. When the condition is met by the attributes, the system automatically performs the action specified in the configurable rule to advance the candidate through the hiring workflow in the applicant tracking system.

### BACKGROUND

### Field

The disclosed embodiments relate to applicant tracking systems. More specifically, the disclosed embodiments relate to techniques for automating candidate workflows in applicant tracking systems using configurable rules and network signals.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

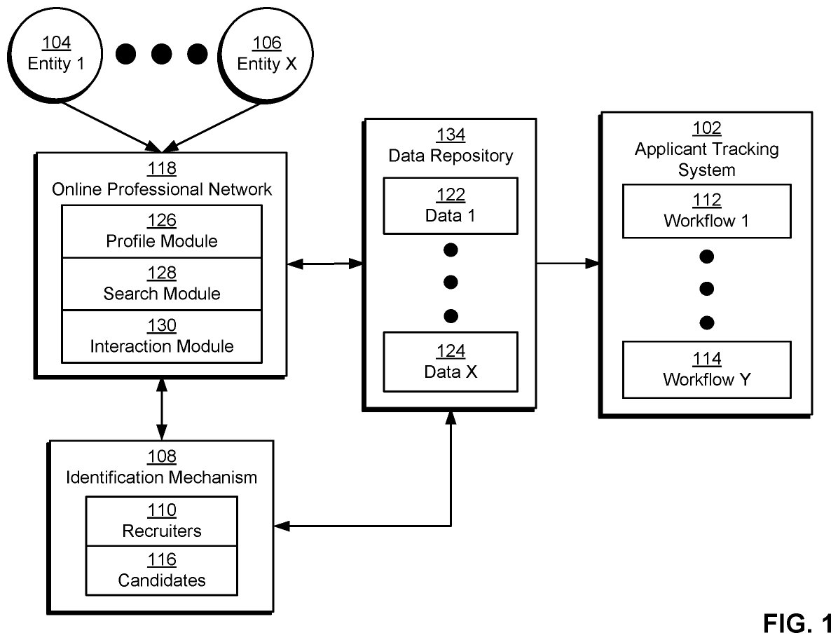

The disclosed embodiments provide a method, apparatus, and system for automating candidate workflows related to recruiting and/or hiring using configurable rules and network signals. As shown in FIG. 1, the workflows (e.g., workflow 1 112, workflow y 114) may be executed, managed, and/or tracked by an applicant tracking system 102 that is used with an online professional network 118 and/or another community of users.

Online professional network 118 allows a set of entities (e.g., entity 1 104, entity x 106) to interact with one another in a professional and/or business context. The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, member profiles and/or activity with online professional network 118 are used by or with an applicant tracking system (ATS) 102 to guide and/or improve decisions and actions by recruiters 110, hiring managers, human resources professionals, and/or other “moderators” involved in hiring and/or recruiting. ATS 102 may allow the moderators to manage, schedule, and/or track emails, messages, phone screens, onsite interviews, programming and/or skills assessments, auditions, and/or other types of interaction related to screening candidates 116 for jobs, positions, roles, and/or opportunities. ATS 102 may also allow the moderators to monitor the availability of candidates 116 for new opportunities, manage resumes and/or applicant profiles, search for and/or filter candidates 116 for the opportunities, and/or connect or communicate with candidates 116 via built-in and/or external messaging mechanisms.

ATS 102 may be provided by and/or accessed through online professional network 118. For example, ATS 102 may form a part of a recruiting product and/or tool offered by or through online professional network 118. As a result, ATS 102 may integrate with other features of online professional network 118, such as profile module 126, search module 128, and/or interaction module 130. Recruiters 110 and/or other moderators may use the features to search for candidates 116 with qualifications for certain opportunities, view professional profiles and/or resumes of candidates 116, send and receive messages with candidates 116, track the candidates' interest in opportunities, and/or otherwise supplement activities and/or interactions related to hiring and recruiting.

ATS 102 may also, or instead, be used and/or implemented separately from online professional network 118. For example, ATS 102 may be provided by a standalone application and/or service. In turn, ATS 102 may access some or all data and/or features available on online professional network 118 through one or more application-programming interfaces (APIs) and/or other communications mechanisms with online professional network 118.

As shown in FIG. 1, an identification mechanism 108 identifies recruiters 110 and candidates 116 associated with ATS 102. First, identification mechanism 108 may identify candidates 116 as users who have applied to jobs, positions, roles, and/or opportunities, within or outside online professional network 118. Identification mechanism 108 may also, or instead, identify candidates 116 as users and/or members of online professional network 118 with skills, work experience, and/or other attributes or qualifications that match the corresponding jobs, positions, roles, and/or opportunities.

Second, identification mechanism 108 may identify recruiters 110 as members of online professional network 118 and/or other users who have paid and/or registered accounts with ATS 102 and/or a recruiting tool provided by or through online professional network 118. Recruiters 110 may also, or instead, include users that are identified by identification mechanism 108 as having skills, experience, job titles, industries, and/or other qualifications for performing hiring and/or recruiting.

Identification mechanism 108 and/or another component of the system may also include functionality to obtain user input for specifying recruiters 110, candidates 116, and/or other entities involved in placing and/or applying for opportunities. For example, the component may include a user interface that allows a recruiter, sourcer, hiring manager, human resources professional, and/or other moderator involved in screening for and/or placing jobs, positions, roles, and/or opportunities to associate one or more candidates 116 and/or recruiters 110 with job requisitions managed through ATS 102.

As mentioned above, ATS 102 includes functionality to automate hiring workflows for job candidates 116 using configurable rules and network signals. A hiring workflow may include multiple stages that start with identifying a potential candidate for a position and ends in hiring of the candidate for the position. In between the beginning and end of the hiring workflow, stages of the hiring workflow may involve receiving an application for the position from the candidate, review of the application by a recruiter or hiring manager, an assessment of the candidate's skills or qualifications, one or more phone screens with the candidate, one or more interview rounds with the candidate, a background check for the candidate, and/or consulting professional references of the candidate. As the candidate interacts with a recruiter, hiring manager, and/or another user of ATS 102, the candidate may advance through various stages of the workflow until the candidate is hired, the position is filled using another candidate, and/or the position is cancelled or frozen.

To automate portions of the hiring workflows, ATS 102 may match online professional network 118 attributes and/or activity associated with candidates 116 to user-configurable rules. Each rule may include one or more triggers that are matched to activity associated with a given candidate, one or more conditions that are evaluated using attributes associated with the activity and/or candidate, and one or more actions to be performed when the specified condition(s) are met. The rules and/or actions may thus allow recruiters 110 and/or other users of ATS 102 automate portions of workflows related to communicating with candidates 116, scheduling interviews or other events with candidates 116, moving candidates 116 between stages of the workflows, and/or generating notifications related to candidates 116 to the users.

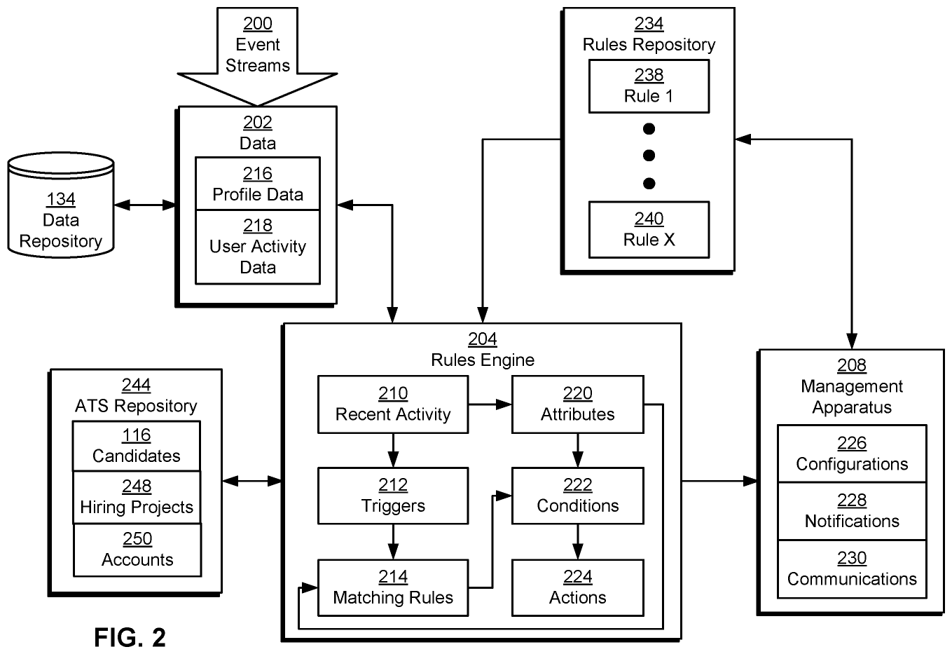

As shown in FIG. 2, automation of hiring workflows for candidates 116 in an ATS (e.g., ATS 102 of FIG. 1) involves the use of data 202 from data repository 134, which includes profile data 216 for members of a social network (e.g., online professional network 118 of FIG. 1) or other community of users, as well as user activity data 218 that tracks the members' and/or candidates' activity within and/or outside the community. Profile data 216 may include data associated with member profiles in the community. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, patents or publications associated with the user, and/or other data related to the user's interaction with the community.

Attributes of the members may be matched to a number of member segments, with each member segment containing a group of members that share one or more common attributes. For example, member segments in the community may be defined to include members with the same industry, title, location, and/or language.

Connection information in profile data 216 may additionally be combined into a graph, with nodes in the graph representing entities (e.g., users, schools, companies, locations, etc.) in the community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of user interactions with one another and/or content associated with the community. For example, user activity data 218 may be used to track impressions, clicks, likes, dislikes, shares, hides, comments, posts, updates, conversions, and/or other user interaction with content in the community. User activity data 218 may also, or instead, track other types of community activity, including connections, messages, job applications, interaction between candidates 116 and recruiters, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may additionally include schedules, calendars, and/or upcoming availabilities of the users, which may be used to schedule meetings, interviews, and/or events for the users. Like profile data 216, user activity data 218 may be used to create a graph, with nodes in the graph representing community members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

Profile data 216, user activity data 218, and/or other data 202 in data repository 134 may be standardized before the data is used by components of the system. For example, skills in profile data 216 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

The ATS additionally maintains data related to hiring workflows and/or candidates 116 in an ATS repository 244. For example, ATS repository 244 may be provided by a relational database, distributed filesystem, and/or other data store. ATS repository 244 may be maintained in the same data store as data repository 134, or in a separate data store from data repository 134.

ATS repository 244 includes records of candidates 116, which can include members that have applied to job postings, conducted job searches, and/or otherwise exhibited job-seeking behavior or preferences. Candidates 116 in ATS repository 244 may also, or instead, include members that are identified as strong matches or “quality applicants” for certain job postings based on work experience, education, skills, endorsements, industry, title, and/or other profile data 216 from data repository 134. Each record may include an identifier for a candidate, profile data 216 for the candidate, one or more hiring projects 248 (e.g., job requisitions) with which the candidate is affiliated, the stage of the candidate in the hiring workflow for each hiring project, and/or other data that is relevant to hiring or recruiting of the candidate within the ATS.

ATS repository 244 also includes records that define and/or track the status of hiring projects 248. For example, each record may include a name or unique identifier for a hiring project, a set of fields describing a job to be filled using the hiring project (e.g., employer, industry, position, summary, job description, location, skills, requirements, salary, benefits, etc.), an account and/or subscription under which the hiring project is managed, and/or a status of the hiring project (e.g., open, closed, filled, cancelled, frozen, etc.). The record may also identify and/or link to one or more recruiters assigned to the hiring project and/or one or more candidates 116 associated with the hiring project.

ATS repository 244 further includes records that define accounts 250 used to access the ATS. Each account may represent a company, recruiting agency, and/or other entity that uses the ATS to manage or conduct hiring and/or recruiting activities. As a result, ATS repository 244 may include a record that contains a unique identifier for the account, a name of the account, one or more recruiters that use the account to access the ATS, and/or one or more hiring projects 248 opened or managed under the account.

In one or more embodiments, the system of FIG. 2 uses changes and/or updates to profile data 216, user activity data 218, and/or records in ATS repository 244 to automatically advance candidates 116 through hiring workflows in the ATS. Some or all of the changes and/or updates may be received as records of recent activity 210 over one or more event streams 200, such as event streams that are generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 from a source of truth for data 202 and/or data repository 134. For example, an event containing a record of a recent profile update, job search, job view, job application, connection invitation, post, like, comment, share, and/or other recent member activity within or outside the community and/or ATS may be generated in response to the activity. The record may then be propagated to components subscribing to event streams 200 on a nearline basis.

A rules engine 204 receives records of recent activity 210 related to candidates 116 via event streams 200 and uses the records to identify and/or evaluate configurable rules (e.g., rule 1 238, rule x 240) stored in a rules repository 234. As mentioned above, the rules may include triggers 212, conditions 222, and actions 224 that are used to automate portions of hiring workflows within the ATS. For example, each rule may be defined as a tuple of a trigger, a condition, and an action. In turn, the rule may be evaluated using the following form:
WHEN (trigger) AND (condition) THEN (perform action)

More specifically, triggers 212 represent categories of recent activity 210 that “trigger” the evaluation of the corresponding rules. For example, each rule may include a trigger type that represents a change in the stage of a candidate within a given hiring workflow, submission of a job application by the candidate, a change in a profile attribute of the candidate (e.g., from profile data 216), archiving of a candidate for a position, reviewing a candidate for a position, receiving interview feedback for a candidate, and/or a communication (e.g., email, online network message, etc.) between a candidate and a recruiter, hiring manager, or other user of the ATS. In general, the trigger may represent activity that occurs within the online network and/or is otherwise received through the online network or ATS.

When an event containing a record of recent activity 210 is received over one or more event streams 200, rules engine 204 matches one or more fields in the record to trigger types of triggers 212 specified in one or more configurable rules. For example, rules engine 204 may obtain, from one or more fields in the record, a resource, method, request, table, snapshot, and/or other entity to which recent activity 210 pertains. Next, rules engine 204 may query rules repository 234 and/or another data store for rules and/or types of triggers 212 that match the field(s).

Triggers 212 may also, or instead, specify a lapse in time (e.g., a certain number of days, weeks, or months) since one or more of types of recent activity 210 have occurred. As a result, rules engine 204 may include one or more background processes that set timers that count down after recent activity 210 has occurred. When the countdown for a certain activity has completed, rules engine 204 and/or another component may generate or activate a trigger indicating a corresponding lapse of time since the activity occurred.

After one or more triggers 212 are found or activated for a given record of recent activity 210, rules engine 204 uses attributes 220 associated with the record and/or recent activity 210 to identify one or more matching rules 214 that pertain to the record. For example, each rule in rules repository 234 may be defined for a given hiring project, account, candidate, recruiter, and/or other entity represented in ATS repository 244. Rules engine 204 may obtain, from attributes 220, identifiers for one or more entities to which the record pertains (e.g., a candidate and/or recruiter involved in or affected by the corresponding recent activity 210, an account in the ATS, a hiring project, etc.). Rules engine 204 may then identify matching rules 214 by querying rules repository 234 for rules that contain triggers 212 and some or all of the same identifiers.

After matching rules 214 for a given record of recent activity 210 are identified, rules engine 204 evaluates conditions 222 defined in matching rules 214 using additional attributes 220 associated with recent activity 210. Conditions 222 include logical statements (e.g., logical operators and/or operands) that evaluate to true or false. As a result, attributes 220 may be used as input in evaluating the statements in conditions 222.

For example, attributes 220 may include profile data 216 and/or user activity data 218 for a candidate, a match score representing the extent to which the applicant matches or fits a position, the candidate's current and/or previous stage in a hiring workflow for the position, a status of the candidate within the ATS (e.g., interested or uninterested in new opportunities, considered for a hiring project, reviewed under a hiring project, archived under a hiring project, etc.), a review or rating of the candidate, an email or other communication between a user of the ATS and the candidate, and/or interview feedback for the candidate. In turn, conditions 222 may include thresholds, equality or inequality comparisons, and/or other true-false statements involving attributes 220, such as a minimum and/or maximum match score for the member; certain values for the current stage, previous stage, and/or status of the candidate in a hiring workflow; a minimum and/or maximum rating or interview result for the candidate; and a status of communication between the candidate and a recruiter (e.g., message sent from the recruiter to the candidate, response to the message received from the candidate, response to the message not received from the candidate, etc.).

Conditions 222 may be modeled using a condition tree with leaf nodes representing logical operands that are connected via logical operators. For example, a rule may include a complex condition with the following form:
candidate current stage==REVIEW AND (candidate is a quality applicant OR hiring manager rating >=GOOD)
   The condition may be represented by a tree with three levels. The lowest level includes two leaf nodes representing the “candidate is a quality applicant” and “hiring manager rating >=GOOD” statements. The middle level of the tree includes an “OR” operator connecting the leaf nodes at the lowest level, as well as a third leaf node representing the “candidate current stage==REVIEW” statement. The top level of the tree includes an “AND” operator connecting the “OR” operator and the third leaf node in the middle level of the tree. As a result, the condition may be evaluated by evaluating all three statements as true or false (e.g., determining if the hiring manager rating of the candidate is at least GOOD, if the candidate is identified as a quality applicant, and if the candidate's current stage is set to REVIEW), applying a logical disjunction to the first two statements, and applying a logical conjunction to the result of the logical disjunction and the third statement.

When conditions 222 in one or more matching rules 214 are met (i.e., when logical expressions representing conditions 222 evaluate to true), rules engine 204 automatically performs one or more actions 224 specified in the matching rule(s). Actions 224 may include changes to records for candidates 116, hiring projects 248, accounts 250, and/or other entities represented in ATS repository 244. For example, actions 224 may include moving a candidate from a first stage in the hiring workflow to a second stage in the hiring workflow, archiving a candidate for a position (e.g., when the candidate is currently unavailable or the position has been filled), initiating a background check on the candidate, initiating a skills assessment for the candidate, and/or scheduling an interview or phone screen with the candidate. To perform actions 224, rules engine 204 may issue calls to one or more application programming interfaces (APIs) with the ATS, ATS repository 244, and/or other components involved in managing and/or executing hiring workflows in the ATS. Each call may include identifiers for the relevant applicant (i.e., candidate), hiring project, account, and/or other entities related to or affected by the corresponding rule. The call may also indicate and/or identify the action to be performed and/or one or more fields or values used to carry out the action (e.g., setting a field representing the stage of a candidate in a hiring workflow to a specific value).

One or more actions 224 may also, or instead, be carried out by a management apparatus 208 associated with the ATS. For example, management apparatus 208 may provide a user interface and/or messaging system within or outside the ATS. As a result, management apparatus 208 may perform actions 224 such as transmitting notifications 228 and/or communications 230 related to recent activity 210. Such notifications and/or communications may include, but are not limited to, transmitting an email or message to the candidate using a template, transmitting a reminder to the candidate to perform an action (e.g., respond to a message after no response was received for a certain number of days, provide availability for an interview or phone screen, etc.), and/or generating a notification about relevant recent activity 210 from the candidate (e.g., a change in job-seeking status, applying to a job, updating profile data 216, changing employers, a work anniversary, etc.).

Management apparatus 208 further includes functionality to obtain configurations 226 of rules from users of the ATS. For example, management apparatus 208 may provide a user interface, tool, and/or other mechanism that allows the users to create rules that apply to specific candidates 116, hiring projects 248, accounts 250, and/or other entities defined in ATS repository 244. After selecting one or more entities to which a given rule applies, the user may choose a trigger for the rule, use logical statements and/or operators to define a condition for the rule, and select one or more actions to execute. The trigger, statements, and/or actions may be selected from a list of options and/or defined by the user (e.g., using a developer API and/or domain-specific language (DSL)). The user may also, or instead, update an existing rule in rules repository 234 using management apparatus 208 (e.g., by changing a trigger, condition, and/or action specified in the rule).

Those skilled in the art will appreciate that two or more matching rules 214 with conditions 222 that evaluate to true for a given record of recent activity 210 may specify actions 224 that conflict with one another.

Such conflicting actions 224 may be illustrated using the following example rules:
Rule 1: WHEN candidate applies for a job AND (NULL) THEN move candidate to “potential candidate” stage
Rule 2: WHEN candidate applies for a job AND candidate is a quality applicant THEN move the candidate to “phone screen” stage
   In the above example, both rules have conditions that are met when a candidate applies for a job and is a quality applicant. The first rule may specify setting the candidate's stage in a hiring workflow to “potential candidate,” and the second rule may specify the candidate's stage in the hiring workflow to “phone screen.” Because the candidate is associated with only one stage in a given hiring workflow, the actions defined in the rules may conflict with one another.

Conflicts in actions 224 and/or the associated matching rules 214 may also include repeated, cyclical execution of rules in a loop. Such loop-based execution of rules may be illustrated using the following example rules:
Rule 1: WHEN candidate moves stages AND (fromStage=‘A’ AND toStage=13′) THEN move candidate to stage ‘C’
Rule 2: WHEN candidate moves stages AND (fromStage=‘B’ AND toStage=‘C’) THEN move candidate to stage ‘A’
Rule 3: WHEN candidate moves stages AND (fromStage=‘C’ AND toStage=‘A’) THEN move candidate to stage ‘B’
   The definition and/or configuration of the three rules above may lead to an infinite loop that repeatedly executes all three rules when a trigger and/or condition in one of the rules is met.

In one or more embodiments, rules engine 204, management apparatus 208, and/or another component of the system include functionality to resolve conflicting actions 224 and/or cyclical execution of rules. First, the component may resolve conflicting actions 224 in two more matching rules 214 by selecting an action to carry out based on priorities associated with the corresponding rules. The priorities may be manually specified by a user (e.g., through a user interface and/or tool provided by management apparatus 208) and/or determined based on evaluation criteria associated with the rules.

For example, a user may provide an ordering of rules by increasing or decreasing priority and/or assign a numeric priority to each rule (e.g., 1 to 10, with 1 representing the highest priority and 10 representing the lowest priority). In turn, the component may resolve conflicting actions 224 in the rules by selecting an action to perform from the rule with the highest priority.

The component may also, or instead, use evaluation criteria for generating priority scores for the conflicting rules based on the corresponding triggers 212, conditions 222, and/or actions 224. The evaluation criteria may be specified by users and/or administrators of the ATS. Example criteria may include, but are not limited to, prioritizing moving a candidate to a higher stage in a hiring workflow over moving the candidate to a lower stage in the same hiring workflow and/or selecting a given communication to transmit to a candidate (out of multiple communications identified in two or more actions 224). In turn, the component may resolve the conflict by using the evaluation criteria to generate priority scores for rules with conflicting actions 224 and selecting, for execution, the action from the rule with the highest priority score.

Second, the component may detect cyclical triggering or execution of rules by monitoring the evaluation results of rules engine 204 and/or actions 224 taken by rules engine 204 and/or management apparatus 208. When the component detects that a given rule or set of rules is triggered in a repeated and/or continuous fashion, the component may flag the rule(s) and terminate execution of the rule(s). The component may also, or instead, generate an alert or notification of the cyclical execution to facilitate manual resolution of the issue by a user.

By leveraging network signals from an online community and user-defined rules to automate portions of hiring workflows in the ATS, the system of FIG. 2 may reduce manual overhead associated with using the ATS to conduct recruiting or hiring activities, streamline use of the ATS, improve user experiences with the ATS for both recruiters and candidates 116, and/or increase efficiency in managing hiring workflows through the ATS. In turn, recruiters and/or other users of the ATS may customize the rules to meet their preferences, requirements, and/or needs and/or to expedite tasks performed or tracked using the ATS. Conversely, conventional techniques for automating workflows in an ATS may be limited to rules that trigger based on explicit actions or signals within the ATS, such as sending or receiving messages within the ATS and/or moving candidates between stages in the workflows. Consequently, the system of FIG. 2 may improve applications and computer technologies related to recruiting, communication, and/or online networks, as well as user engagement, user experiences, and user interaction through the applications and technologies and/or network-enabled devices used to access the applications and technologies.

Those skilled in the art will appreciate that the system of FIG. 2 may be implemented in a variety of ways. First, rules engine 204, management apparatus 208, data repository 134, rules repository 234, and ATS repository 244 may be provided by a single physical machine, multiple computer systems, one or more virtual machines, a grid, one or more databases, one or more filesystems, and/or a cloud computing system. Rules engine 204 and management apparatus 208 may additionally be implemented together and/or separately by one or more hardware and/or software components and/or layers.

Second, rules, data 202, events in event streams 200, configurations 226, notifications 228, communications 230, and/or other data used by the system may be stored, defined, and/or transmitted using a number of techniques. For example, communications 230 may include emails, SMS messages, chat messages, social media messages, voicemails, phone calls, teleconferences, and/or videoconferences. In another example, notifications 228 may be transmitted within the ATS, the online community, and/or other mechanisms for interacting with users. In a third example, the system may store data in data repository 134, rules repository 234, and/or ATS repository 244 in a number of formats, including database records, property lists, Extensible Markup language (XML) documents, JavaScript Object Notation (JSON) objects, flat files, and/or other types of structured data.

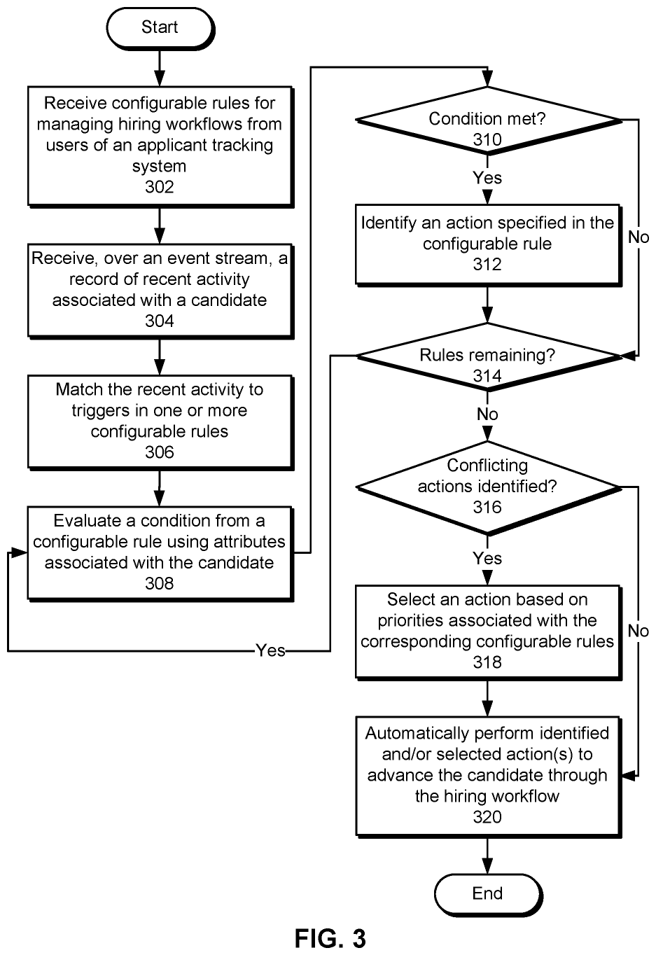

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, configurable rules for managing hiring workflows are received from users of an ATS (operation 302). Each configurable rule may include one or more triggers, conditions, and actions. Each configurable rule may be defined, customized, and/or updated by a user to automate one or more portions of a hiring workflow in the ATS. After a configurable rule is defined, the configurable rule may be stored in a repository, such as rules repository 234 of FIG. 2, for subsequent retrieval and use.

Examples of configurable rules that can be used with the ATS include the following:
Rule 1: WHEN a recruiter moves a candidate into a “phone screen” stage AND NULL THEN send an email using the “phone screen” template to the candidate
Rule 2: WHEN a phone screen is scheduled AND the hiring manager has accepted a calendar invite for the phone screen THEN send an email with a “phone screen” review link to the hiring manager
Rule 3: WHEN a recruiter archives a candidate for a hiring workflow AND the candidate is a quality applicant THEN create a notification to follow up after three months
Rule 4: WHEN a recruiter archives a candidate for a hiring workflow AND the candidate is a quality applicant THEN create a notification whenever the candidate's profile attributes or job-seeking status change
   The first rule may automate the scheduling of a phone screen with a candidate, once the candidate advances to the phone screen stage of a hiring workflow. The second rule may streamline reviewing of the candidate by a hiring manager after the phone screen is scheduled. The third rule may be used to remind a recruiter to reach out to a highly qualified candidate a number of months after the candidate is archived for a given position (e.g., because the candidate is currently unavailable and/or a different candidate was chosen for the position) to allow the recruiter to explore other opportunities with the candidate. The fourth rule may allow the recruiter to reach out to a highly qualified candidate anytime the candidate is perceived to be open to or available for new opportunities.

Next, a record of recent activity associated with a candidate is received over an event stream (operation 304). For example, the record may be generated in response to activity by a member of an online network that is identified as a candidate and/or a candidate that is identified independently of the online network and received over an event stream that is provided by a distributed stream-processing platform and/or a CDC pipeline.

The recent activity is matched to triggers in one or more of the configurable rules (operation 306). For example, a set of configurable rules with trigger types that match the recent activity may be identified. The trigger types may include, but are not limited to, a change in a current stage of the candidate within the hiring workflow, an application of the candidate for a job posting, a change in a profile attribute of the candidate in the online network, archiving of the candidate for a position, review of the candidate for the position, interview feedback for the candidate, a communication from a user of the ATS to the candidate, and/or a lapse in time since the recent activity. After the trigger types are matched to the recent activity, a subset of the configurable rules may further be matched to the recent activity based on attributes such as an applicant identifier for the candidate, a hiring project, an account used to create or manage the hiring project, and/or a profile attribute of the member in the online network.

After configurable rules that are relevant to the recent activity are identified, a condition from a configurable rule is evaluated using attributes associated with the candidate (operation 308). The condition may include a number of logical operands that are connected by logical operators. The operands may include, but are not limited to, comparisons and/or evaluations related to a threshold for a match score between the candidate and a position, a current stage of the candidate in the hiring workflow, a previous stage of the candidate in the hiring workflow, a status of the candidate within the ATS, a result of reviewing the candidate for a position, an interview feedback result for the candidate, a rating of the candidate for the position, and/or a communication from a user of the ATS to the candidate.

The condition may be met (operation 310) by the corresponding attributes. If the condition is not met, evaluation of the rule may stop. If the condition is met, an action specified in the configurable rule is identified (operation 312). For example, the action may be obtained from the configurable rule and stored for subsequent evaluation and/or execution. The action may include, but is not limited to, moving the candidate from a first stage in the hiring workflow to a second stage in the hiring workflow, archiving the candidate for a position, initiating a background check on the candidate, initiating a skills assessment for the candidate, scheduling a phone screen with the candidate, scheduling an interview with the candidate, transmitting a communication to the candidate, and/or generating a notification related to the candidate.

Operations 308-312 may be repeated for remaining rules (operation 314) that match the recent activity and/or corresponding attributes. After conditions in all matching rules have been evaluated and actions associated with conditions that are met are identified, the actions may be evaluated to determine if conflicting actions have been identified (operation 316) from rules with conditions that are met by the attributes. For example, the conflicting actions may include two or more actions that move the member to different stages of the hiring workflow.

If no conflicting actions are found, the identified actions are automatically performed to advance the candidate through the hiring workflow (operation 320). If conflicting actions are found, an action is selected based on priorities associated with the corresponding configurable rules (operation 318). For example, the action may be selected based on priorities that are assigned to the rules by one or more users and/or priorities that are determined using evaluation criteria associated with the triggers, conditions, and/or actions in the rules. Once the action is selected from a set of conflicting actions, the action is performed (operation 320) without performing other actions that conflict with the selected action.

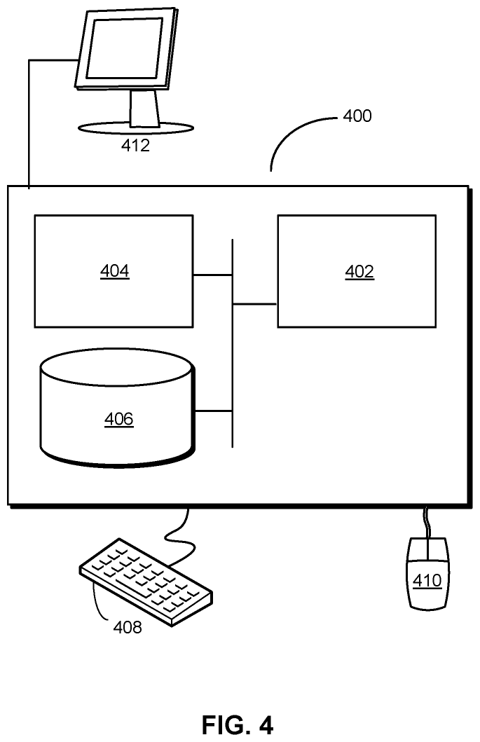

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes a rules engine and a management apparatus, one or more of which may alternatively be termed or implemented as a module, mechanism, or other type of system component.

The rules engine matches recent activity associated with a candidate in an ATS to a trigger in a configurable rule for managing a hiring workflow for the member. Next, the rules engine evaluates a condition from the configurable rule using attributes associated with the candidate. When the condition is met by the attributes, the rules engine and/or management apparatus automatically perform an action specified in the configurable rule to advance the candidate through the hiring workflow in the ATS.

The management apparatus also receives, from a user of the applicant tracking system, an update to the configurable rule. Next, the rules engine matches additional recent activity associated with an additional member in the online network to the update. The rules engine and/or management apparatus then automatically perform an updated action specified in the update.

In addition, one or more components of computer system 400 may be remotely located and connected to the other components over a network. Portions of the present embodiments (e.g., rules engine, management apparatus, data repository, rules repository, ATS repository, etc.) may also be located on different nodes of a distributed system that implements the embodiments. For example, the present embodiments may be implemented using a cloud computing system that automates hiring workflows for a set of remote candidates and/or applicants in an ATS.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
storing, in a repository, a set of configurable rules for managing hiring workflows in an applicant tracking system, wherein each configurable rule in the set of configurable rules comprises a trigger representing activity associated with an online network, a condition to be evaluated in response to the trigger, and an action to be performed when the condition is met;
matching, by one or more computer systems, recent activity associated with a candidate in the applicant tracking system to the trigger in a configurable rule from the repository;
evaluating, by the one or more computer systems, the condition from the configurable rule using attributes associated with the candidate; and
when the condition is met by the attributes, automatically performing the action specified in the configurable rule to advance the candidate through a hiring workflow in the applicant tracking system.

2. The method of claim 1, further comprising:
receiving a record of the recent activity from an event stream prior to matching the recent activity to the trigger.

3. The method of claim 2, wherein the event stream is generated by at least one of:
a distributed streaming platform; and
a change data capture (CDC) platform.

4. The method of claim 1, wherein matching the recent activity associated with the candidate to the trigger in the configurable rule for managing the hiring workflow for the candidate comprises:
identifying a set of rules with a trigger type that matches the recent activity; and
identifying the configurable rule for managing the hiring workflow for the candidate based on the attributes associated with the candidate.

5. The method of claim 4, wherein the attributes comprise at least one of:
an applicant identifier;
a hiring project;
an account; and
a profile attribute of the candidate in the online network.

6. The method of claim 1, further comprising:
receiving, from a user of the applicant tracking system, an update to the configurable rule;
matching additional recent activity associated with an additional candidate to the update; and
automatically performing an updated action specified in the update.

7. The method of claim 1, wherein the trigger comprises at least one of:
a change in a current stage of the candidate within the hiring workflow;
an application of the candidate for a job posting;
a change in a profile attribute of the candidate in the online network;
archiving of the candidate for a position;
review of the candidate for the position;
interview feedback for the candidate for the position;
a communication from a user of the applicant tracking system to the candidates; and
a lapse in time since the recent activity.

8. The method of claim 1, wherein the condition comprises at least one of:
a threshold for a match score between the candidate and a position;
a current stage of the candidate in the hiring workflow;
a previous stage of the candidate in the hiring workflow;
a status of the candidate within the applicant tracking system;
a result of reviewing the candidate for a position;
an interview feedback result for the candidate for the position;
a rating of the candidate for the position; and
a communication from a user of the applicant tracking system to the candidate.

9. The method of claim 1, wherein the condition comprises a logical operator connecting two logical operands.

10. The method of claim 1, wherein the action comprises at least one of:
moving the candidate from a first stage in the hiring workflow to a second stage in the hiring workflow;
archiving the candidate for a position;
initiating a background check on the candidate;
initiating a skills assessment for the candidate;
scheduling a phone screen with the candidate;
scheduling an interview with the candidate;
transmitting a communication to the candidate; and
generating a notification related to the candidate.

11. The method of claim 1, further comprising:
identifying a conflict between the action and an additional action specified in an additional configurable rule; and
selecting the action for advancing the candidate through the hiring workflow based on priorities associated with the configurable rule and the additional configurable rule.

12. The method of claim 11, wherein the priorities are based on at least one of:
user input provided to the applicant tracking system; and
evaluation criteria associated with the rule and the additional rule.

13. A system, comprising:
one or more processors; and
memory storing instructions that, when executed by the one or more processors, cause the system to:
store, in a repository, a set of configurable rules for managing hiring workflows in an applicant tracking system, wherein each configurable rule in the set of configurable rules comprises a trigger representing activity associated with an online network, a condition to be evaluated in response to the trigger, and an action to be performed when the condition is met;
match recent activity associated with a candidate in the applicant tracking system to the trigger in a configurable rule from the repository;
evaluate the condition from the configurable rule using attributes associated with the candidate; and
when the condition is met by the attributes, automatically perform the action specified in the configurable rule to advance the candidate through a hiring workflow in the applicant tracking system.

14. The system of claim 13, wherein matching the recent activity associated with the candidate to the trigger in the configurable rule for managing the hiring workflow for the candidate comprises:
identifying a set of rules with a trigger type that matches the recent activity; and
identifying the configurable rule for managing the hiring workflow for the candidate based on the attributes associated with the candidate.

15. The system of claim 14, wherein the attributes comprise at least one of:
an applicant identifier;
a hiring project;
an account; and
a profile attribute of the candidate in the online network.

16. The system of claim 13, wherein the trigger comprises at least one of:
a change in a current stage of the candidate within the hiring workflow;
an application of the candidate for a job posting;
a change in a profile attribute of the candidate in the online network;
archiving of the candidate for a position;
review of the candidate for the position;
interview feedback for the candidate for the position;
a communication from a user of the applicant tracking system to the candidate; and
a lapse in time since the recent activity.

17. The system of claim 13, wherein the condition comprises at least one of:
a threshold for a match score between the candidate and a position;
a current stage of the candidate in the hiring workflow;
a previous stage of the candidate in the hiring workflow;
a status of the candidate within the applicant tracking system;
a result of reviewing the candidate for a position;
an interview feedback result for the candidate for the position;
a rating of the candidate for the position; and
a communication from a user of the applicant tracking system to the candidate.

18. The system of claim 13, wherein the condition comprises a logical operator connecting two logical operands.

19. The system of claim 13, wherein the action comprises at least one of:
moving the candidate from a first stage in the hiring workflow to a second stage in the hiring workflow;
archiving the candidate for a position;
initiating a background check on the candidate;
initiating a skills assessment for the candidate;
scheduling a phone screen with the candidate;
scheduling an interview with the candidate;
transmitting a communication to the candidate; and
generating a notification related to the candidate.

20. A non-transitory computer-readable storage medium storing instructions that when executed by a computer cause the computer to perform a method, the method comprising:
storing, in a repository, a set of configurable rules for managing hiring workflows in an applicant tracking system, wherein each configurable rule in the set of configurable rules comprises a trigger representing activity associated with an online network, a condition to be evaluated in response to the trigger, and an action to be performed when the condition is met;
matching, by one or more computer systems, recent activity associated with a candidate in the applicant tracking system to the trigger in a configurable rule from the repository;
evaluating, by the one or more computer systems, the condition from the configurable rule using attributes associated with the candidate; and
when the condition is met by the attributes, automatically performing the action specified in the configurable rule to advance the candidate through a hiring workflow in the applicant tracking system.
